(19) United States
(12) Patent Application Publication
(10) Pub. No.: US 2013/0031995 A1
(43) Pub. Date: Feb. 7, 2013

(54) BALL SCREW

(71) Applicant: Feng-Tien Chen, Taichung City (TW)

(72) Inventor: Feng-Tien Chen, Taichung City (TW)

(21) Appl. No.: 13/530,427

(22) Filed: Jun. 22, 2012

(30) Foreign Application Priority Data
Aug. 4, 2011 (TW) 100127721

(51) Int. Cl. F16H 25/22

(52) U.S. Cl. 74/424.83

(57) ABSTRACT

A ball screw includes a screw shaft formed with two helical raceways that have the same lead and the same thread angle, a ball nut rotatably sleeved on the screw shaft and formed with two ball grooves that correspond to and complement with the helical raceways, a scraper has two contact parts to contact the two helical raceways, a plurality of bearing balls rollably and selectively disposable between one of the ball grooves and the corresponding helical raceway, and a return unit including two return tubes each having two ends respectively and spatially connected to two ends of the corresponding ball groove.

### CROSS-REFERENCE TO RELATED APPLICATION

This application claims priority to Taiwanese Application No. 100127721, filed on Aug. 4, 2011.

### BACKGROUND OF THE INVENTION

1. Field of the Invention

The invention relates to a ball screw, and more particularly to a ball screw having a reserve helical raceway.

2. Description of the Related Art

Ball screws are transmission components widely used in machine tools, optoelectric apparatuses, semiconductor apparatuses, and precision medical apparatuses. The ball screws have advantages of high precision, high efficiency, and reversibility.

Referring to FIG. 1, a first conventional ball screw includes a screw shaft 11, a ball nut 12 rotatably sleeved on the screw shaft 11, a plurality of bearing balls 13 disposed between the screw shaft 11 and the ball nut 12, and scrapers 14. The screw shaft 11 includes a shaft body 111 with an outer shaft surface 112 formed with a helical raceway 113. The screw nut 12 includes a nut body 121 with an inner nut surface 122 formed with a ball groove 125 that corresponds to and complements with the helical raceway 113. The bearing balls 13 are rollably disposed between the ball groove 125 and the helical raceway 113. The scrapers 14 are disposed at the inner nut surface 122.

Referring to FIG. 2, a second conventional ball screw is shown to be similar to the first conventional ball screw. The second conventional ball screw is a twin-lead ball screw, whose screw shaft 11 includes two helical raceways 113, whose screw nut 12 includes two ball grooves 125 that respectively correspond to and complement with the helical raceways 113, and whose bearing balls 13 are respectively disposed between the helical raceways 113 and the ball grooves 125 corresponding thereto. The ball screw is suited for high-load applications due to simultaneous use of the two helical raceways 113.

Referring to FIG. 3, a third conventional ball screw is shown to be similar to the first conventional ball screw. The third conventional ball screw is a high-lead ball screw, whose screw shaft 11 includes three helical raceways 113, whose screw nut 12 includes three ball grooves 125 that respectively correspond to and complement with the helical raceways 113, and whose bearing balls 13 are respectively disposed between the helical raceways 113 and the ball grooves 125 corresponding thereto. The ball screw is suited for high lead applications due to simultaneous use of the three helical raceways 113.

From small apparatuses to giant industrial machines, price of the ball screw used therein may reach thousands of dollars. When the helical raceways 113 are worn out and lose precision, the user must tear down the whole set of the ball screw and install a new one, thereby resulting in high cost and long re-installation time. Moreover, because the helical raceways 113 of the twin-lead and the high-lead ball screws are used simultaneously, the precision of the thread angle and the screw pitch of the helical raceways 113 must be high, thus incurring a higher processing cost.

### SUMMARY OF THE INVENTION

Therefore, an object of the present invention is to provide a ball screw having a reserve helical raceway for facilitating re-installation and for saving cost.

According to the present invention, a ball screw comprises:

a screw shaft including a shaft body with an outer shaft surface formed with two helical raceways that have the same lead and the same thread angle;

a ball nut rotatably sleeved on the screw shaft and including a nut body with an inner nut surface formed with two ball grooves that correspond to and complement with the helical raceways, respectively;

a scraper disposed at the inner nut surface and having two contact parts to contact the two helical raceways, respectively;

a plurality of bearing balls rollably and selectively disposable between one of the ball grooves and the corresponding one of the helical raceways; and

a return unit provided at the nut body and including two return tubes each corresponding to one of the ball grooves, each having two ends respectively and spatially connected to two ends of the corresponding one of the ball grooves, and each being configured to permit passage of the bearing balls therethrough.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective partly cutaway view showing a first conventional ball screw;

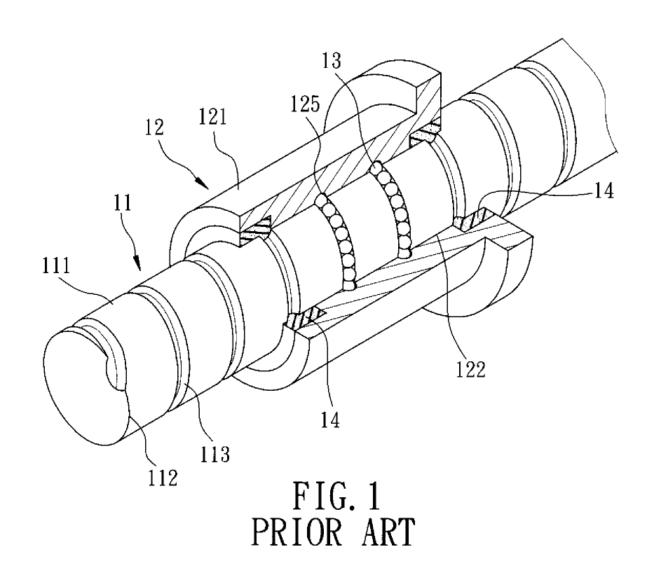

FIG. 2 is a perspective partly cutaway view showing a second conventional ball screw;

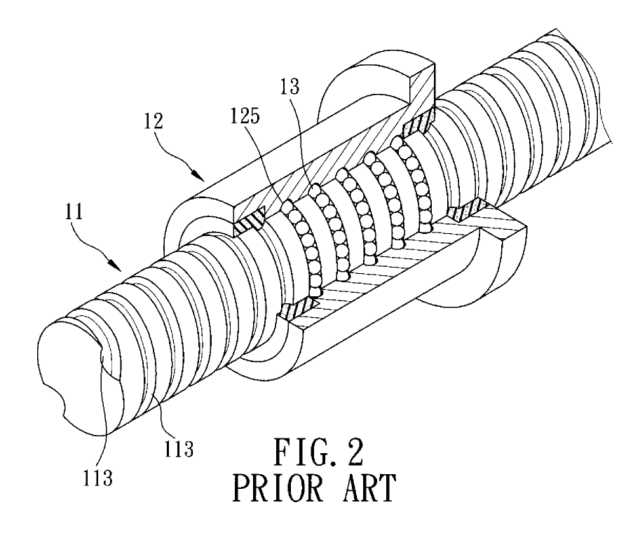

FIG. 3 is a perspective partly cutaway view showing a third conventional ball screw;

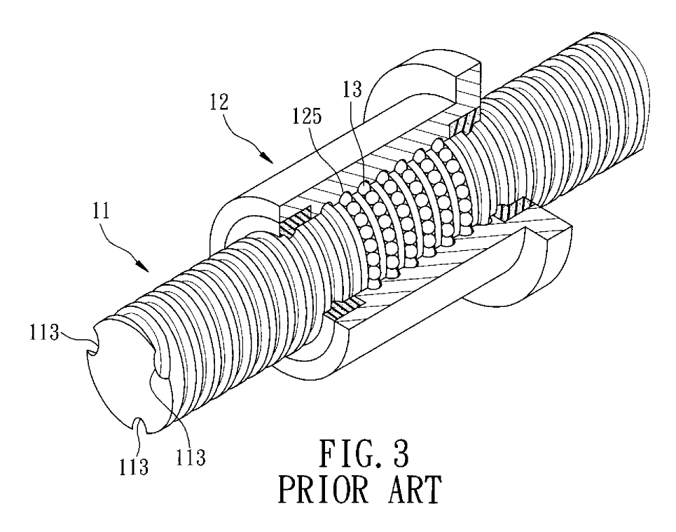

FIG. 4 is a perspective partly cutaway view showing a first preferred embodiment of the ball screw according to the present invention;

FIG. 5 is a sectional view for showing a return unit of the first preferred embodiment;

FIG. 6 is a perspective partly cutaway view showing a second preferred embodiment of the ball screw according to the present invention; and

FIG. 7 is a sectional view for showing a return unit of the second preferred embodiment.

### DETAILED DESCRIPTION OF THE PREFERRED EMBODIMENTS

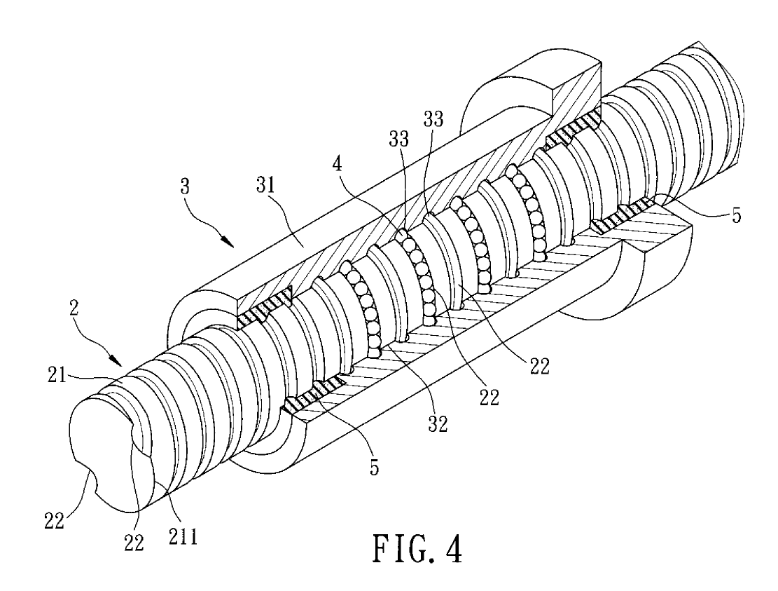

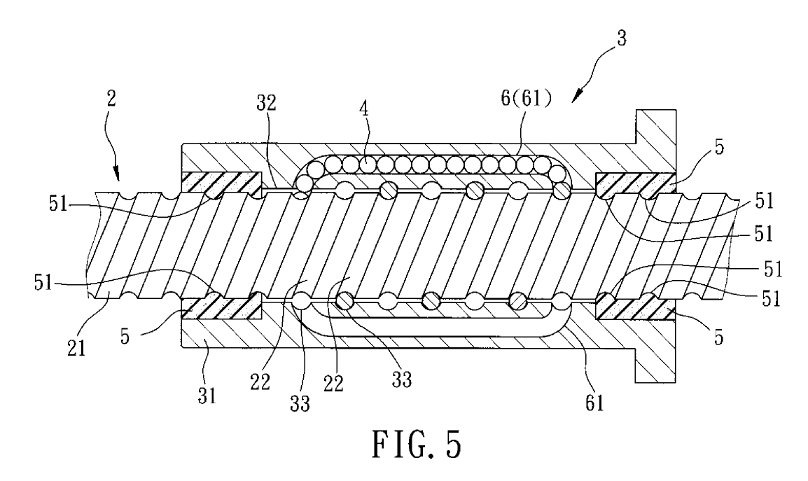

Referring to FIG. 4 and FIG. 5, the first preferred embodiment of the ball screw according to this invention is shown to include a screw shaft 2, a ball nut 3, a plurality of bearing balls 4, at least one scraper 5, and a return unit 6. In this embodiment, the ball screw includes two scrapers 5.

The screw shaft 2 includes a shaft body 21 with an outer shaft surface 211 formed with two first helical raceways 22 that are interlaced thereon and that have the same lead and the same thread angle.

The ball nut 3 is rotatably sleeved on the screw shaft 2 and includes a nut body 31 with an inner nut surface 32 formed with two first ball grooves 33 that correspond to and complement with the first helical raceways 22, respectively.

The bearing balls 4 are rollably and selectively disposable between one of the first ball grooves 33 and the corresponding one of the first helical raceways 22.

Each scraper 5 is disposed at the inner nut surface 32 and has two first contact parts 51 to contact the two first helical raceways 22, respectively.

The return unit 6 is provided at the nut body 31 and includes two first return tubes 61 each corresponding to one of the first ball grooves 33, each having two ends respectively and spatially connected to two ends of the corresponding first ball groove 33 to form a ball circulation loop, and each being configured to permit passage of the bearing balls 4 therethrough.

In use, only one of the first helical raceways 22 has the bearing balls 4 disposed therein at any time, so that the bearing balls 4 only roll in one loop composed of the first helical raceway 22, the corresponding first ball groove 33, and the corresponding first return tube 61, and the other first helical raceway 22, the other first ball groove 33, and the other first return tube 61 are reserved for backup. The scrapers 5 rotate relative to the screw shaft 2 with rotation of the nut body 31 of the ball nut 3, such that the first contact parts 51 are capable of removing undesired objects (not shown) on the first helical raceways 22. When the first helical raceway 22 having the bearing balls 4 is worn out to thereby lose precision, the ball nut 3 can be removed for installation of the bearing balls 4 into the other first helical raceway 22. Then, the ball nut 3 is re-sleeved on the screw shaft 2, and the ball screw can be re-used by such a simple process.

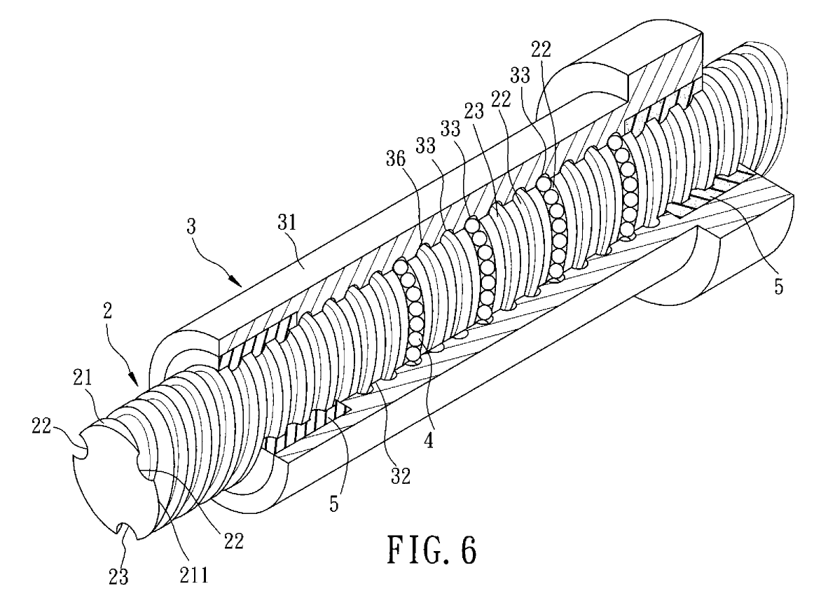

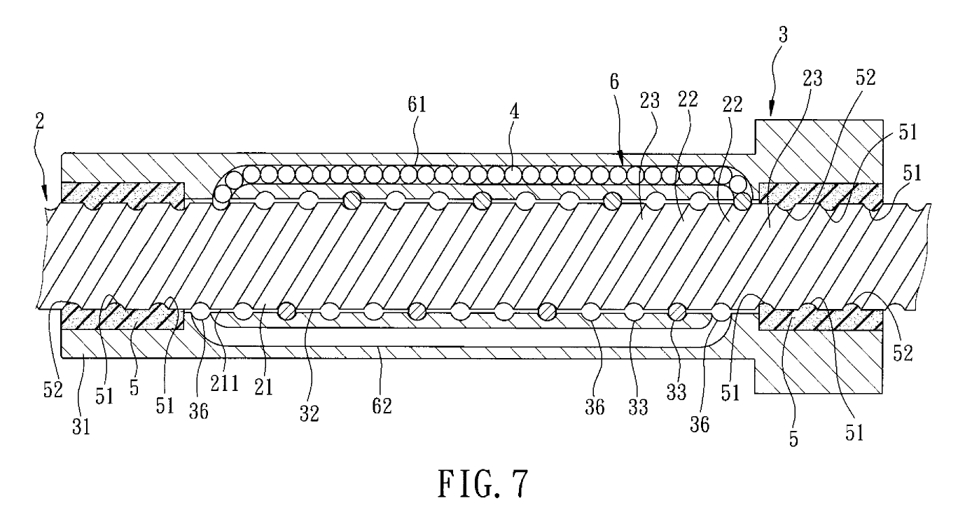

Referring to FIG. 6 and FIG. 7, the second preferred embodiment of the ball screw according to the present invention is shown to include a screw shaft 2, a ball nut 3, a plurality of bearing balls 4, at least one scraper 5, and a return unit 6. In this embodiment, the ball screw includes two scrapers 5.

The second preferred embodiment is similar to the first preferred embodiment, and the differences therebetween are described as follows.

The outer shaft surface 211 of the shaft body 21 of the screw shaft 2 is further formed with a second helical raceway 23 interlaced with the first helical raceways 22 thereon and having the same lead and the same thread angle as the first helical raceways 22.

The inner nut surface 32 of the nut body 31 of the ball nut 3 is further formed with a second ball groove 36 corresponding to and complementing with the second helical raceway 23.

Each scraper 5 further has a second contact part 52 to contact the second helical raceway 23.

The return unit 6 further includes a second return tube 62 corresponding to the second ball groove 36, having two ends respectively and spatially connected to two ends of the second ball groove 36 to forma ball circulation loop, and configured to permit passage of the bearing balls 4 therethrough.

The bearing balls 4 are rollably and selectively disposable between the second ball groove 36 and the second helical raceway 23. Only one of the first and second helical raceways 22, 23 has the bearing balls 4 disposed therein at any time.

Thus, the ball screw is single-lead and has a reserve first helical raceway 22 and a reserve second helical raceway 23. When two first helical raceways 22 are worn out to thereby lose precision, the ball nut 3 can be removed for installation of the bearing balls 4 into the second helical raceway 23. Then, the ball nut 3 is re-sleeved on the screw shaft 2, and the ball screw can be re-used, to thereby save cost and re-installation time.

It should be noted that the first helical raceways 22 of the ball screw according to the present invention are not used at the same time, and only one of the helical raceways 22, 23 is used at any time, so that precision requirements of the thread angle and the lead are much lower than those of a twin-lead ball screw and a high-lead ball screw, to thereby reduce production cost.

To sum up, in the present invention, the bearing balls 4 are only disposed between one of the helical raceways 22, 23 formed on the screw shaft 2 and the corresponding ball grooves 33, 36 of the ball nut 3, such that when one of the helical raceways 22 is worn out by the bearing balls 4 to thereby lose precision, the bearing balls 4 can be installed into any of the reserve helical raceways 22, 23 for re-use through a simple installation process, so that replacement of the whole ball screw is not necessary, thereby saving cost and time of replacement.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A ball screw comprising:
a screw shaft including a shaft body with an outer shaft surface formed with two first helical raceways that have the same lead and the same thread angle;
a ball nut rotatably sleeved on said screw shaft and including a nut body with an inner nut surface formed with two first ball grooves that correspond to and complement with said first helical raceways, respectively;
a scraper disposed at said inner nut surface and having two first contact parts to contact said two first helical raceways, respectively;
a plurality of bearing balls rollably and selectively disposable between one of said first ball grooves and the corresponding one of said first helical raceways; and
a return unit provided at said nut body and including two first return tubes each corresponding to one of said first ball grooves, each having two ends respectively and spatially connected to two ends of the corresponding one of said first ball grooves, and each being configured to permit passage of said bearing balls therethrough.

2. The ball screw as claimed in claim 1, wherein only one of said first helical raceways has said bearing balls disposed therein at any time.

3. The ball screw as claimed in claim 2, wherein said first helical raceways are interlaced on said outer shaft surface.

4. The ball screw as claimed in claim 1, wherein:
said outer shaft surface is further formed with a second helical raceway having the same lead and the same thread angle as said first helical raceways;
said inner nut surface being further formed with a second ball groove corresponding to and complementing with said second helical raceway;
said scraper further having a second contact part to contact said second helical raceway;
said bearing balls being rollably and selectively disposable between said second ball groove and said second helical raceway;
said return unit further including a second return tube, having two ends respectively and spatially connected to two ends of said second ball groove, and configured to permit passage of said bearing balls therethrough.

5. The ball screw as claimed in claim 4, wherein only one of said first and second helical raceways has said bearing balls disposed therein at any time.

6. The ball screw as claimed in claim 5, wherein said first and second helical raceways are interlaced on said outer shaft surface.
